(19) United States
(12) Patent Application Publication
(10) Pub. No.: US 2010/0023419 A1
(43) Pub. Date: Jan. 28, 2010

(54) SERVICE REQUEST SYSTEM

(75) Inventor: Katie Louise Tyler, London (GB)

Correspondence Address: KNOBBE MARTENS OLSON & BEAR LLP, 2040 MAIN STREET, FOURTEENTH FLOOR, IRVINE, CA, 92614, US

(73) Assignee: Barmate Limited, London (GB)

(21) Appl. No.: 12/441,872

(22) PCT Filed: Oct. 11, 2007
(86) PCT No.: PCT/GB07/03867

§ 371 Date: May 15, 2009

(30) Foreign Application Priority Data
Oct. 13, 2006 (GB) 0620410.1

(51) Int. Cl. G06Q 50/00

(52) U.S. Cl. 705/26; 701/300

(57) ABSTRACT

A service request system comprises a number of request units (5) located within a service area (1), a number of receivers (4), a location unit and a display. The request unit comprises a manual control and wireless radio transmitter and sends a radio request for service signal in response to operation of the manual control. A receiver receives a request for service signal and reports reception of the request for service signal and the relative position, relative to itself, of the request unit to the location unit. The location unit derives the location of the sending request unit within the service area from the report and relative position and shows this location on the display.

This invention relates to a service request system and in particular to a service request system for use in bars and hotels.

It is usual for hotels having bars and lounge areas to allow guests to order refreshments from wherever they are seated in the bar or lounge area. However, it may be a problem to provide an expected or acceptable level of service in hotel or resort complexes having large external lounge and bar areas such as pool side areas, sun terraces and the like because of the physical size of the guest areas where service may be desired.

This is a particular problem for resort or hotel complexes using walls, foliage and landscaping to cut down noise and to allow guests some privacy, because the more complex layout of the service area makes it impossible for a member of staff to see more than a small part of the service area at any time.

In general it is desired and expected by guests, that it should be possible to obtain services such as the ordering and provision of food and drinks wherever a guest is located in the service area without undue delays.

There is a problem in providing this desired level of service, particularly in large service areas, that guests may have to wait for an unacceptably long time for a staff member to pass close enough to attract their attention and request service, or a guest may have to move to a bar or similar ordering point themselves to request service. These problems are more likely to be encountered where service is provided across physically large areas and where the layout of the serviced area is more complex.

It is of course possible to raise the service to a desired level by increasing the number of waiters or other service staff, but this can increase costs to unacceptable levels.

A number of known systems allowing guests to remotely request service are disclosed in US2003/0182209A1, GB1424379A, WO83/04327A1, DE4425289A1, JP2003141637A, JP03192386A and U.S. Pat. No. 4,777,488. However, these systems all depend upon the service request being associated with a fixed location such as a seat or table number and so cannot be used to provide service to guests able to move freely around a large area.

Another known system allowing guests to remotely request service is disclosed in US2003/0088469A1 and U.S. Pat. No. 6,681,109B1. This system allows guest requests for service to be notified to a server by pager message. The message identifies the guest requesting service to the server by table number so that these systems also depend upon the service request being associated with a fixed table number and so cannot be used to provide service to guests able to move freely around a large area. If it is attempted to use this system in an service area where tables are not fixed and guests are able to move the tables, and themselves, around the service area there is a problem that servers cannot identify or locate guests requesting service on the basis of the provided table numbers. This is because the tables can be moved around, and as a result the server cannot deduce the location of a table, or a guest requesting service at the table, from the table number.

This problem is particularly severe where service is provided across physically large areas or where the layout of the serviced area is more complex so that servers are unable to check each table in turn until they locate and identify the guest who has made a request for service.

A number of systems are also known for determining the location of persons or objects but not for enabling guests to remotely request service. U.S. Pat. No. 5,898,367 discloses a system for determining and displaying the location of persons requiring assistance, U.S. Pat. No. 5,483,244 discloses a system for locating a mobile communication unit making unauthorised use of a network, and EP0543500 discloses a system for determining the location of patients in a hospital. All of these systems rely on triangulation between multiple receivers to determine the location of the person or object of interest. As a result these systems require a large number of receivers to ensure that every part of the area covered by the system is covered by multiple receivers and also require a complex interconnection of the receivers to allow the necessary correlation and triangulation of signals received at the different receivers so that the systems are complex and expensive. Further, setting up the system to ensure that every part of the area covered by the system is covered by multiple receivers is complex and time consuming. As a result, such known systems are too expensive for use to allow guests to remotely request service.

The present invention has been made in order to solve these problems.

In a first aspect, this invention provides a service request system for use in a bar or lounge area to request service from service staff and comprising at least one moveable request unit located within the bar or lounge area, at least one receiver located about the bar or lounge area, a location unit and a display, the request unit comprising a manual control and wireless radio means adapted to send a radio request for service signal in response to operation of the manual control, the receiver being adapted to receive the request for service signal and determine the relative location, relative to itself, of the request unit, and to report reception of the request for service signal to the display, the location unit being adapted to calculate the location of the request unit within the bar or lounge area from the determined relative location and the location of the receiver, and the display being adapted to show this calculated location to service staff.

According to the service request system of the present invention the location unit calculates the location of the request unit sending a request for service and the display unit shows this calculated location to service staff. As a result, the service staff are informed of the location of the guest requesting service so that they are able to quickly and easily locate and identify the guest requesting service, and provide the desired services, even when the guests are able to freely move tables, and other furniture, around a large and complex area. Accordingly, the problems discussed above can be overcome.

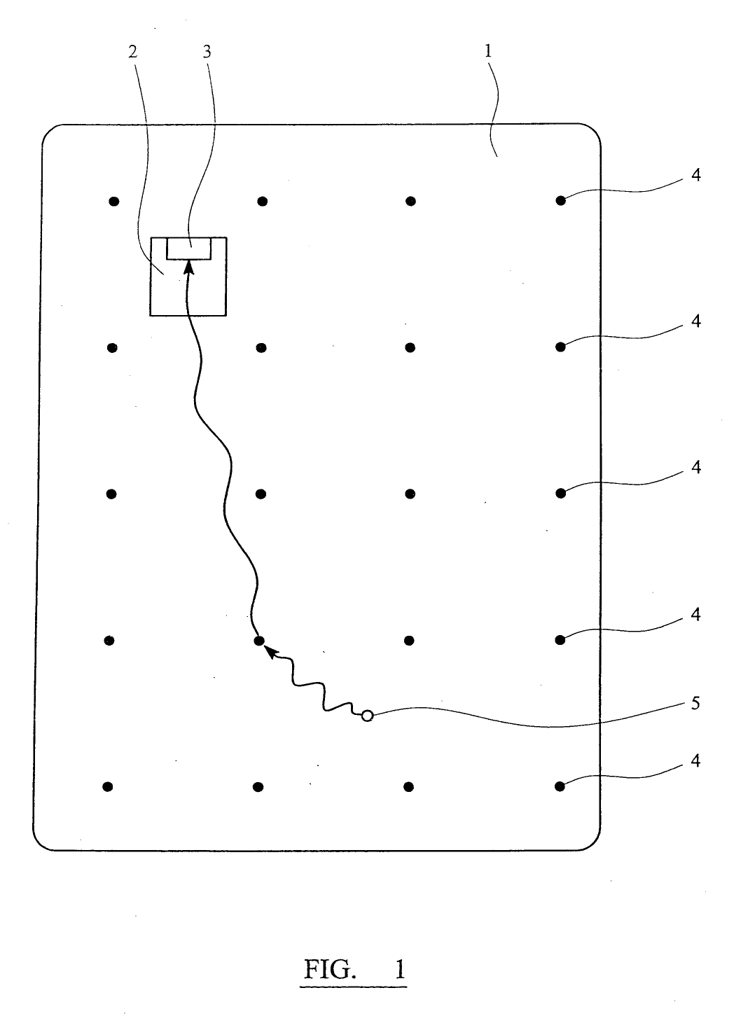

Embodiments of the invention will now be described with referenced to the accompanying diagrammatic FIG. 1.

FIG. 1 shows a plan view of a system according to the invention when in use.

A first embodiment of the invention will now be described with reference to FIG. 1. FIG. 1 shows a pool side seating and sun terrace area 1 associated with a hotel and served by a bar 2.

A large number of items of guest furniture, typically chairs, recliners, loungers, beds and the like, are located within the area 1. For brevity this guest furniture will be referred to as chairs below, but other types of furniture may be used. The chairs can be freely moved around within the service area 1 by guests so that the guests can sit or rest wherever they wish within the area 1.

The service request system according to the invention comprises a central terminal or console 3 located in the bar 2 and a plurality of wireless radio receiver units 4 located about the area 1. In FIG. 1 the receivers 4 are shown arranged across the area 1 approximately in a grid array. The receivers 4 may in principle be arranged across or around the area 1 in any convenient configuration which provides adequate reception coverage for service request units throughout the area 1.

Each of the chairs provided for use by the guests incorporates a service request unit 5. As explained above, the chairs are intended to be moved around freely by the guests. In order not to interfere with such movement the service request units 5 are battery powered so that no power cables are required

The use of battery power is not essential, but will usually be preferred to allow free movement. However, a cable power supply could be used if desired.

Each service request unit 5 comprises a request for service button, a wireless radio transmitter and a visual service request indicator.

When a guest requires service, they can request service by pressing the request for service button on their chair. The service request unit 5 will respond by providing a positive visual indication to the guest that the request for service button has been pressed and the service request has been sent by activating an LED which illuminates the request for service button. The service request unit 5 further transmits a radio signal indicating that a request for service has been made.

If the guest wishes to cancel the request for service they can simply press the request for service button again. The service request unit 5 responds by ending the visual indication by stopping illumination of the LED, this provides a positive visual indication to the guest that the request for service has been cancelled. The service request unit further stops transmission of the request for service radio signal.

The illumination of the request for service button by an LED is a preferred way of providing a visual indication of the making of a request for service. Other types of illumination could be used instead of an LED. Further, alternative means of providing a visual indication of the making of a request for service could be provided instead of or in addition to illumination of the button. One alternative means of providing a visual indication would be for the request for service button to remain depressed after it is pressed for the first time and to return to its normal position only when it is pressed for a second time.

The radio signal emitted by the service request unit 5 making a request for service is received by one of the wireless radio receivers 4. The receiver 4 receiving the request for service signal analyses the received signal to determine the relative position of the service request unit 5 making the request for service relative to itself. That is, the receiver 4 determines the direction and distance from itself of the service request unit 5 making the request for service. Then, the receiver 4 sends a report signal to the central console 3 identifying itself and the relative position of the service request unit 5 from which the request for service signal has been received. The report signal may be sent from the receiver 4 directly to the central console 3 or may be sent through one or more other receivers 4 acting as repeaters or relays, as appropriate under the communication method used. The report signal may alternatively be sent through one or more other service request units 5 acting as repeaters if desired. However this will require suitable components for reception and retransmission to be included in the service request units acting as repeaters.

The receivers 4 can use any known technique for communication with the central console 3, such as a standard wireless networking arrangement.

The central console 3 contains stored information regarding the location of all of the receivers 4. The central console 3 uses the known stored position of the receiver 4 reporting receipt of a request for service signal and the relative position information in the report signal to calculate the location of the service request unit 5 issuing the request for service and generates a notification that a request for service has been received together with the physical location within the service area 1 of the requesting service request unit 5 so that staff can move to the location of the guest requesting service and provide them with the desired service.

Conveniently, the central console 3 can be provided by a suitably programmed personal computer (PC).

In order to allow the receiver 4 to determine the relative position of the service request unit 5 each receiver 4 includes a directionally sensitive radio receiving antennae and a signal strength measuring unit able to measure the signal strength of the received request for service signal.

All of the service request units 5 are arranged to transmit a request for service signal at a predetermined fixed signal transmission strength. Accordingly, because the rate of reduction in received signal strength over distance is predictable, the receiver 4 can calculate the distance between itself and the service request unit 5 sending the request for service signal from the measured signal strength of the received request for service signal.

Each receiver 4 includes a directionally sensitive radio receiver antennae comprising a plurality of directional antennae elements arranged facing in different directions to receive signals from different contiguous sectors so that the direction from which a request for service signal is received can be determined based upon which of the antennae elements has received the request for service signal. Conveniently, the antennae elements can be arranged in a circle in a common horizontal plane or alternatively rectilinearly.

Accordingly, the receiver 4 is able to determine the relative position, relative to itself, of the service request unit 5 sending the request for service signal. The receiver 4 sends this determined relative position information to the central console 3 as part of the report signal. It is expected that in practice the relative position will usually be sent in the form of a distance and bearing of the service request unit 5 from the receiver 4. However, alternative relative position formats could be used if preferred, such as relative coordinates giving the position of the service request unit 5 relative to the receiver 4 as a distance along the north-south axis and a distance along the east-west axis.

In the embodiment described above the receiver 4 determines the relative position of the service request unit 5 and sends this relative position to the central console 3. The central console 3 then uses this determined relative position together with the stored known location of the receiver 4 to calculate the absolute location of the service request unit 5 issuing a request for service. Alternatively, it is possible for the receiver 4 to store its own known position and use it's own stored known position together with the determined relative position of the service requesting unit 5 to calculate the absolute position of the service requesting unit 5 making the request for service and send this calculated absolute position information to the central console 3 when reporting receipt of radio request for service signal.

Either of these approaches can be used as convenient in any specific application. However, it is expected that it will usually be preferred to store the positions of the receivers 4 at the central console 3 and calculate the absolute positions of the service request units 5 issuing a request for service at the central console 3. This is because most systems will include many more receivers 4 than central consoles 3 so that it is desirable to carry out as many functions as possible at the central console 3 to reduce the expense of the more numerous receivers 4 and so reduce the overall expense of the system.

It is to be understood that receivers 4 can use alternative methods of determining the relative position of the service request unit 5 in addition to the example above. For example, instead of determining the distance between the service request unit 5 receiver 4 based upon received signal strength it would be possible to measure the distance based upon time of flight of the received signal, that is the time delay between the signal being transmitted and received. In order to do this it will be necessary for the transmitted request for service signal to include information regarding the time in which it was sent. Further, all of the service request units 5 and receivers 4 in the system will need to include synchronised clocks so that transmission and receipt times of request for service signals can be accurately compared. Similarly, instead of using antennae comprising plural antennae elements receiving signals from contiguous sectors to determine direction other arrangements could be used. For example, plural antennae elements receiving signals from overlapping sectors could be used so that the direction from which a service request signal is received can be calculated by comparing the signal strength received at adjacent antennae elements.

Any other known method for measuring distance and direction to a signal source can also be used, for example, the or each receiver could include a phased array of a plurality of spaced apart antennae elements together with means for comparing the phases of the received signal at the different antennae elements. The difference in phase of the received signal at the different elements can then be used to determine the direction from which the signal is received.

As explained above, in practice the service request system according to the invention will normally comprise a plurality of receivers so that it is possible that a single request for service sent by a single service request unit 5 could be received by multiple receivers 4. Accordingly, it is desirable to provide means to identify duplicate reports of the same request for service signal from different receivers 4 and eliminate the duplicate reports so that only a single request for service is reported to staff in order to prevent the system and/or the staff being overloaded by such multiple reporting of requests for service.

A preferred method of identifying and eliminating multiple reporting of a request for service is for each request for service signal to include the identity of the sending service request unit 5 and the time at which the request was sent so that each request for service can be uniquely identified. Provided that this service request unit identity and time of issue of the request is included in the report signal to the central console 3 from each receiver 4, it is extremely simple for the central console 3 to identify duplicate reports of the same request for service and discard the duplicate reports.

It is not essential that the time of issue is used to uniquely identify a request for service signal. For example each service request unit 5 could consecutively number each request for service signal it sends so that the combination of the identity of the sending service request unit 5 and the sequential number will uniquely identify each request for service signal.

Another alternative approach is to include only the identity of the sending service request unit 5 in the request for service signal without any unique identifier of different messages. This approach relies on the fact that in practice the time taken for a radio signal to propagate across the entire area covered by the service request system is extremely short so that the difference in the time of receipt of the same request for service signal at different receivers 4 is very short. As a result the central console 3 can compare the times of receipt of request for service signals received at different receivers 4 from the same service request unit 5 and assume that the signals received within a short predetermined period of one another are multiple receptions of the same request for service signal so that only one needs to be processed and the duplicates can be discarded. Further, if the length of the request for service signal is comparable to or larger than the time taken for a signal to propagate across the area covered by the service request system it will be possible to confirm that different receivers 4 are reporting reception of the same request for service signal when different parts of the signal have been simultaneously received at different receivers 4 so that they must be the same request for service signal.

If the identity of the sending service request unit 5 is not included in the request for service signal an alternative approach would be for the central console 3 to compare the calculated absolute location and time of receipt of the requests for service reported by different receivers 4 and to assume that requests for service sent from the same or very close locations at the same or very close times are different reports of the same request for service. However, this approach is generally not preferred in a system where absolute positions are calculated by the central console 3 because of the increased number of positions which will have to be calculated for the duplicate reports of the same request for service before the duplicate reports can be identified and deleted. However, this disadvantage will not apply in systems where the absolute position are calculated by the individual receivers 4 and reported to the central console 3.

The approaches disclosed above are examples only and any known method of calculating the location of a transmitter relative a receiver could be used.

Preferably, the central console 3 provides both notification that a request for service has been received and indicates the location of the service request unit 5 and thus the location of the guest requesting service by displaying the calculated location of the service request unit 5 from which the request signal has been received as a cursor on a map of the area 1.

In order to ensure that the request for service cannot easily be overlooked it is preferable for the central console to also emit an audible signal that a request for service has been received. Further, it is preferred that the cursor indicating the location of the service request unit 5 should be highlighted by blinking or use of a colour contrasting to the rest of the map display.

When a member of staff arrives at the location of the guest requesting service they can approach the guest, take their order and press the request for service button again, that is a second time. The request unit 5 then stops sending the request for service and returns to a passive non transmitting state and the request for service button stops giving a visual indication that service has been requested. The staff can then provide the requested service to the guest as appropriate. Alternatively, the staff could press the request for service button for the second time only when the requested services have actually been provided.

It should be understood that use of either of these two procedural options is dependent on the operators and both are entirely supported by the system.

In practice it will often be the case that a number of guests and their chairs, loungers or other furniture will be located close together. In this case, in order to avoid any confusion the staff will be able to identify which guest has requested service because the request for service button on the request unit 5 visually identifies the sending of a request for service.

Preferably, the central console 3 can be advised when a member of staff has been assigned responsibility to deal with a request for service and to indicate this on the display so that multiple members of staff are not mistakenly sent to deal with the same request for service. This process of indicating to the central console 3 that a member of staff has been assigned to deal with a request for service and changing the indication on the display shows this change of status can be carried out using any convenient procedure.

One preferred arrangement is for the visual display provided by the central console 3 to be a touch screen display so that the central console 3 can be informed that a member of staff has been assigned to deal with a request for service by simply touching the screen over the service request cursor.

It is preferred to keep displaying the location of a request for service, until the sending of the request for service is stopped by the service request button of the service request unit 5 being pressed for the second time to cancel the sending of the request for service signal, in order to avoid a request for service being forgotten. In this case, the status of a request for service as to whether a member of staff has been sent to attend to the request for service can be indicated by changing the visual appearance of the request for service cursor. This can be done by changing the colour by changing from a blinking cursor to a continuously light cursor or any other convenient indication.

It would of course be possible to stop displaying the location of a request for service on the visual display immediately a member of staff is assigned to deal with the request for service. However, it this is generally not preferred because this could lead to confusion between requests for service which have been allocated to staff to be dealt with and requests for service which are cancelled by guests.

The receivers 4 are fixed when the system is operating and communicate by wireless radio links with the central console 3. Alternatively, physical connections such cable or fibre optic links could be used between the receivers 4 and the central console 3. However, the use of wireless links is preferred so that the system can be quickly and easily set up or reconfigured without requiring the installation or rerouting of physical connections.

The use of a cable or mains power supply for the receivers 4 is preferred because the power required by a receiver 4 is expected to be much greater than a service request unit 5.

However, a battery power supply could also be used. If a battery power supply is used, solar cells or photo-voltaic elements can advantageously be provided to extend battery life.

The use of fixed receivers 4 which remain at fixed locations relative to one another when the service request system is in use is preferred in order the simplify operation of the system.

Advantageously, in addition to the mode of use described above to provide service requests, the receivers 4 and the central console 3 can also be operated in a calibration mode in which radio signals are sent between the different receivers 4 in order to allow the locations of the receivers 4 within the area 1 to be calculated. This location information is then stored in the memory of the central console 3 and/or in the or each receiver, as necessary. In practice, this calibration function should be carried out when the system is first installed, after any of the receivers 4 have been moved and periodically as necessary to keep the system operating accurately.

It would of course be possible for service request units to be incorporated into items other than furniture or be provided as stand alone devices which can be held or carried by guests.

However, this will increase the risk of theft or accidental loss or service request units.

In a second embodiment of the invention, in addition to the visual display at the central console 3 in the bar area 2 the staff are provided with individual portable wireless display units linked to the central console 3. When a request for service is received members of staff can be assigned or take responsibility for dealing with the request for service and indicate this to the central console 3 without having to physically move back to the bar area, so improving efficiency. Further, the use of portable display units by members of staff allows them to confirm the location of the service request unit 5 making a request for service after leaving the bar area where the central console is located so that they cannot forget or become confused about the location.

In a third embodiment of the invention, in addition to the features explained above of the first and second embodiments, each service requesting unit 5 is assigned a unique identity code and includes this identity number in the request for service radio signal. This incorporation of a unique identity code into each request for service signal ensures that where the request for service signal is received by multiple receivers 4 it is correctly identified as a single request for service and not as multiple different requests for service.

Further, in the third embodiment it is preferred that the unique identity code of each service requesting unit 5 is a also clearly indicated on the chair or lounger to which the service request unit 5 is attached and that this code is indicated together with the request for service location cursor on the or each display. This allows a member of staff to clearly identify which guest has made the request for service. The codes will advantageously be numbers or alphanumeric sequences mainly comprising numbers so that the codes can be easily memorised and identified by members of staff.

This arrangement of uniquely coding the service request unit 5 and indicating this code on the display, or otherwise providing the code to the responsible member of staff, can be used as an alternative to the request for service button on the service request unit 5 indicating visually that a request for service has been made.

However, it is preferred to use the unique identification code in addition to the request for service button indicating that a request for service has been made. This provides greater certainty that the member of staff will identify the correct guest who has made the request for service. Further, the button visually indicating that a request for service has been made provides reassurance to the guest that their request for service has been properly made and will be responded to.

The invention is not limited to the use of a single system in isolation. A large area, such as a resort complex for example, could be covered by multiple systems having contiguous service areas.

Further, multiple central consoles could be connected to an array of receivers in an area and different receivers being assignable to form a service request system together with different ones of the central consoles as required. This can be used to form a reconfigurable system able to deal with changing guest numbers. For example, an area could be served by different numbers of bars at different times with receivers being assigned to form service request systems together with central consoles in the open bars only.

In the embodiments described above the location of the or each receiver is stored in the receiver or central console. As an alternative each receiver could calculate it's own position when reporting a request for service signal.

In the embodiments described above the location of the service request unit is calculated by the receivers or central console. As an alternative each service request unit could calculate it's own position and include this in the request for service signal.

The different radio signals can be at any convenient frequency and modulation type. For example, Ultra-Wide band, 2.4 Ghz, 443 MHz, 433 MHz, 303 MHz and 900 MHz radio can all be used, among others.

In the embodiments described above a service request unit 5 sends a service request signal continually from the first time the request for service button is pressed until the second time it is pressed. This continuously sent signal may instead be sent periodically during this period. As a further alternative the service request unit may only send a signal to start and end the request for service, the central console responding to these signals by toggling a request for service status record for the service request unit between a requesting state and a not requesting state. In this case the two toggling signals may be the same or different.

In the above description the sending and processing of a single request for service is often referred to for clarity. It should be understood that in operation a number of requests for service may be being sent by different service request units at the same time.

In the embodiments described above the service request units 5 are active radio transmitters. As an alternative the service request units could be passive devices. The receivers 4 in this alternative will regularly or continuously transmit a radio signal or pulse. When a service request is made the service request unit 5 sends the service request signal to one or more receivers by interacting with their transmitted radio signals or pulses. This interaction can be of any type which can be detected by the receivers 4. For example the service request unit 5 could send a service request signal by changing from a non-reflecting to a reflecting state, or vice-versa, or by changing a coded signal reflected or retransmitted back to the receivers 4.

The receiver, or receivers, 4 can then process and respond to the received signal as in the embodiments described above.

The passive device in the service request unit could for example be a silicon integrated circuit device or a crystalline structure.

The sending of signals from passive devices and suitable passive devices are well known and the skilled person will be able to select a suitable passive device and operating methodology without difficulty.

In the embodiments described above, the request for service unit has a single control button and sends only a simple request for service without indicating what service is required. As an alternative the request for service unit could be provided with a keypad allowing the guest to specify the desired service. The service specification would then be sent as part of the request for service signal and displayed at the central console or forwarded to the appropriate staff portable display units as necessary.

Conveniently in this embodiment, the request for service unit can incorporate a keypad and display of the type used in PDA devices to allow the required service to be specified and confirmed by guests.

As a further embodiment, the request for service could include data identifying the requesting guest for billing purposes. Preferably, each guest is issued with a portable data carrier storing identifying information and each request for service unit includes means able to detect the presence of and read the identifying data from a portable data carrier held in or close to the request for service unit. This identifying data is then sent as part of the request for service signal and provided to a billing system. Conveniently, when the system is used in a resort or hotel the portable data carrier is an electronic guest room key and the identifying data is the guests room number. Suitable data carriers and detection and reading arrangements such as non-contact smart cards are well known.

In the above description embodiments of the invention are described in which the invention is used in a poolside seating and sun terrace area. The invention is suitable for use in bar or lounge areas in general, both indoor and outdoor, or in other outdoor areas such as poolside, garden or beach areas. The invention can be used in any situation where service is to be provided on request to persons in a defined area, regardless of the precise form of the service.

1. A service request system for use in a bar or lounge area to request service from service staff, comprising:
at least one moveable request unit located within the bar or lounge area;
at least one receiver located within the bar or lounge area;
a location unit; and
a display,
wherein the request unit comprises a manual control and wireless radio means which sends a radio request for service signal in response to operation of the manual control,
wherein the receiver receives the request for service signal and determines the relative location, relative to itself, of the request unit, and reports reception of the request for service signal to the display, wherein the location unit calculates the location of the request unit within the bar or lounge area from the determined relative location and the location of the receiver, and wherein the display shows the calculated location to the service staff.

2. A service request system as claimed in claim 1, comprising a plurality of spaced apart receivers located about the bar or lounge area, each of which receives the request for service signal and reports reception to the display.

3. A service request system as claimed in claim 1, in which the receiver reports reception of the request for service signal including the determined relative location to the location unit and the location unit calculates the location of the request unit from the report.

4. A service request system as claimed in claim 1, wherein the location unit is part of the receiver and the calculated location is included in the report of reception of the request for service signal.

5. A service request system as claimed in claim 1 in which the location unit further comprises a memory device in which the location of the or each receiver is stored, and wherein the location unit calculates the location of the request unit from the stored location of the receiver which reports reception of the request for service signal.

6. A service request system as claimed in claim 1 in which the request unit provides a visual indication of operation of the manual control.

7. A service request system as claimed in claim 6 in which the manual control is a press button which remains depressed to provide said visual indication.

8. A service request system as claimed in claim 6, in which the request unit comprises a light which is illuminated to provide said visual indication.

9. A service request system as claimed in claim 1, in which the or each request unit is attached to an item of furniture.

10. A service request system as claimed in claim 9, in which the or each item of furniture is a chair, bed, recliner or lounger.

11. A service request system as claimed in claim 1, comprising a plurality of request units, in which each request unit has a unique identity code which is included in the request for service signal.

12. A service request system as claimed in claim 11, in which the identity codes of request units making a request for service are shown on the display.

13. A service request system as claimed in claim 11, in which the or each request unit is attached to an item of furniture, wherein the identity code is displayed on the item of furniture to which each request unit is attached.

14. A service request system as claimed in claim 13, in which the identity code is an alphanumeric sequence.

15. A service request system as claimed in claim 14, in which the identity code is a number.

16. A service request system as claimed in claim 1, in which the wireless radio means is a wireless radio transmitter.

17. A service request system as claimed in claim 1, in which the receiver emits a radio signal and wherein the wireless radio means is a passive device which sends a radio request for service signal to the receiver by interacting with said emitted radio signal.

18. A service request system according to claim 1, in which the or each request unit further comprises a receiver.

19. A service request system according to claim 1, wherein the receiver determines the distance between the receiver and the request unit according to the strength of the signal received by the receiver.

20. A service request system according to claim 1, wherein the receiver determines the distance between the receiver and the request unit according to the time delay between the signal issuing from the request unit and it being received at the receiver.

21. A service request system according to claim 1, wherein the receiver is arranged to determine the direction from which the signal issuing from the request unit is received.

22. A service request system according to claim 21, wherein the receiver includes at least one of the following for determining the direction from which the signal issuing from the request unit is received: a directionally sensitive radio receiving device, a plurality of antennae elements arranged to receive signals from overlapping sectors and a phased array of a plurality of spaced apart antennae elements and means for comparing the phases of the received signals.

23. A service request system according to claim 1, including a plurality of receivers and means for identifying duplicate reports of the same request for service signal.

24. The service request system as claimed in claim 13, wherein the or each item of furniture is a chair, bed, recliner or lounger.

25. The service request system as claimed in claim 13, wherein the identity codes of request units making a request for service are shown on the display.
